(19) United States
(12) Patent Application Publication
(10) Pub. No.: US 2026/0253781 A1
(43) Pub. Date: Aug. 27, 2026

(54) MAGNETIC ASSEMBLY AND MANUFACTURING PROCESS

(71) Applicant: MetaPWR Electronics Co., Ltd., Shanghai (CN)

(72) Inventors: Qingdong CHEN, Shanghai (CN); Shouyu HONG, Shanghai (CN)

(73) Assignee: MetaPWR Electronics Co., Ltd., Shanghai (CN)

(21) Appl. No.: 19/537,356

(22) Filed: Feb. 11, 2026

(30) Foreign Application Priority Data
Feb. 27, 2025 (CN) 202510221053.4

(51) Int. Cl. H01F 27/24; C25D 7/12; H01F 17/06; H01F 27/26; H01F 27/32; H02K 3/12; H02K 3/28

(52) U.S. Cl. CPC H01F 27/24; C25D 7/123; H01F 17/06; H01F 27/263; H01F 27/325; H02K 3/12; H02K 3/28

(57) ABSTRACT

The present application discloses a magnetic assembly and a manufacturing process. The magnetic assembly comprises a winding assembly and a magnetic core, and the winding assembly comprises a horizontal portion and a vertical portion; by means of different manufacturing processes, on the one hand, increasing the thickness of the winding and reducing the current transmission impedance; on the other hand, the width of the winding gap is reduced, and the better performance of the multi-phase reverse coupling inductor is obtained; and the problem of the flatness of a multi-phase winding is solved.

### CROSS-REFERENCE TO RELATED APPLICATIONS

This application claims the priority benefit of Chinese patent application no. 202510221053.4, filed on Feb. 27, 2025. The entirety of the above-mentioned patent application is hereby incorporated by reference herein and made a part of this specification.

### BACKGROUND

### Technical Field

The present invention belongs to the technical field of high-frequency power supplies, and in particular relates to a magnetic assembly.

### Description of Related Art

In recent years, with the rapid development of data centers, the requirements for power supplies are becoming higher and higher, and a magnetic assembly is very critical component in a power supply. In the magnetic assembly, a magnetic core is mostly made of ferrite and iron powder core. For the iron powder core, the common manufacturing process in the industry is that the winding and the magnetic powder are integrally hot-pressed, especially for a multi-phase structure, a better pin flatness can be achieved; however, the iron powder core belongs to a multi-gap structure, the magnetic permeability is low, and a relatively high steady-state inductance is difficult to achieve. The magnetic permeability of the ferrite is high, which can be better applied to multi-phase reverse coupling inductor, so as a lower dynamic inductance satisfying dynamic requirements is obtained, and the higher steady-state inductance to reduce ripple current can also be achieved, thereby losses are reduced; however, the ferrite cannot be used as the iron powder core and the winding integrated hot-press process; this is because the ferrite is formed by high temperature sintering (up to 1200 degrees), which has exceeded a melting point of a metal copper winding; the common process is to manufacture the ferrite and the winding separately, and then the magnetic core and the winding are assembled, which makes the flatness of the winding challenging; secondly, for a multi-phase reverse coupling inductor, the distance between the windings is very close, and the insulation processing between the windings becomes extremely important; moreover, it is also particularly important to achieve a smaller current transmission impedance to improve efficiency. Therefore, for the multi-phase reverse coupling inductor, the following three problems urgently need to be resolved:
1. Solving the problem of the flatness of the multi-phase winding;
2. Solving close distance between windings while meeting insulation requirements;
3. Achieving a smaller current transmission impedance.

### SUMMARY

In view of the above, one of the objectives of the application is to provide a magnetic assembly comprising a top surface and a bottom surface opposite to each other, a first side surface and a third side surface opposite to each other, a second side surface and a fourth side surface opposite to each other, a winding assembly and a magnetic core, wherein the magnetic core comprises an upper magnetic cover, a lower magnetic cover and a magnetic column, and the magnetic column is disposed between the upper magnetic cover and the lower magnetic cover.

The winding assembly comprises a winding, an upper portion, an insulating layer, a lower portion, a first depth-controlled groove, a second depth-controlled groove, and a through hole, and the upper portion and the lower portion are respectively disposed on a top surface and a bottom surface of the insulating layer; the winding comprises a horizontal portion and a perpendicular portion, the horizontal portion is disposed in the insulating layer, the perpendicular portion is disposed at two ends of the horizontal portion, and the perpendicular portion is penetrated the top surface and the bottom surface of the magnetic assembly; two perpendicular portions of the same winding are respectively arranged on two adjacent side surfaces, and two perpendicular portions arranged on the same side surface are opposite-polarity electrodes; the first depth-controlled groove is recessed from a top surface of the winding assembly, and the first depth-controlled groove is used for accommodating the upper magnetic cover; the second depth-controlled groove is recessed from a bottom surface of the winding assembly, and the second depth-controlled groove is used for accommodating the lower magnetic cover; the through hole is connected to the first depth-controlled groove and the second depth-controlled groove, and the through hole is used for the magnetic column to pass through.

There is a winding gap between the two adjacent winding horizontal portions, and a thickness of the perpendicular portion is equal to a thickness of the horizontal portion.

Preferably, a depth of the first depth-controlled groove is greater than or equal to a thickness of the upper magnetic cover, and a depth of the second depth-controlled groove is greater than or equal to a thickness of the lower magnetic cover.

Preferably, a distance between two vertical portions of the same side surface is less than or equal to the thickness of the perpendicular portion of the winding.

Preferably, a protruding portion is disposed between two perpendicular portions of the same side surface, and the protruding portion maintains electrical insulation between the two perpendicular portions.

Preferably, the magnetic assembly further comprises a signal electrical connector disposed on the side surface of the magnetic assembly and penetrating through the top surface and the bottom surface of the magnetic assembly.

Preferably, the number of the windings is four, and each of the windings comprises the horizontal portion and two perpendicular portions; the winding assembly further comprises a winding groove; the winding groove is disposed between the four horizontal portions, and connected to the first depth-controlled groove and the second depth-controlled groove.

Preferably, the through hole is disposed at four corners of the depth-controlled groove, and is surrounded by the horizontal portion of the winding.

Preferably, an insulating medium is disposed in the winding gap and the winding groove.

Preferably, the number of the windings is four, each of the windings comprises the horizontal portion and two perpendicular portions, and each horizontal portion is independently arranged; the winding assembly further comprises a bottom plate; the bottom plate comprises a plurality of bosses; each boss is arranged adjacent to an end portion of the bottom plate, and there is a boss gap between two adjacent bosses; each horizontal portion of the winding comprises two limiting holes, and the two limiting holes are respectively arranged adjacent to two ends of the winding horizontal portion; the positions of the bosses and the limiting holes are in one-to-one correspondence.

Preferably, the bottom plate is made of a metal material, and the bottom plate further comprises a bottom plate gap; and a width of the bottom plate gap is less than the thickness of the winding horizontal portion.

Preferably, the horizontal portion and the perpendicular portion are integrally and formed to a unit, or the horizontal portion and the perpendicular portion are integrally and formed to a unit and bent to form the perpendicular portion.

A manufacturing process of the magnetic assembly, comprising the following steps.
Step 1: Preparing a metal frame, wherein the metal frame comprises four winding horizontal portions and a connection rib; the connection rib is connected to four winding horizontal portions.
Step 2: Arranging a first bonding layer and a top core plate on a top surface of the metal frame, providing a second bonding layer and a bottom core plate on a bottom surface of the metal frame, and performing high-temperature curing after lamination to form a first blank.
Step 3: In the first blank, performing routing to form a sidewall groove at a corresponding position of each end portion of the winding, so that each end portion is exposed to an inner wall of the sidewall groove; performing a metallization process on the sidewall groove and electroplating, so that a electroplated layer is connected to the corresponding end portion to form a second blank.
Step 4: Routing to precise depth from a top surface and a bottom surface of the second blank respectively to form a first depth-controlled groove and a second depth-controlled groove, and then drilling away the connection rib at a bottom of the depth-controlled groove, or drilling to form the through hole.

Preferably, the metal frame is an integrated panel structure.

The manufacturing process further includes step 5: dividing a plate along the sidewall groove to form the winding assembly; and exposing a part of the electroplated layer to the winding assembly to form the perpendicular portion of the winding.

Preferably, the winding assembly is placed in a fixed-height mold, and a top surface of the upper portion and/or a bottom surface of the lower portion are mechanically ground.

Preferably, the manufacturing process, further comprising the following steps before step 2: pressing an insulating medium on the metal frame, so that the insulating medium is fully filled the winding gap between the metal frames to form a winding insulating layer; and removing the excess insulating medium, so that the top surface and the bottom surface of the metal frame are exposed.

Preferably, the manufacturing process, further, passing the magnetic column through the through hole, and assembling the upper magnetic cover and the lower magnetic cover respectively from the first depth-controlled groove and the second depth-controlled groove to fix the magnetic core and the winding assembly to form the magnetic assembly.

Preferably, the magnetic core and the winding assembly are fixed in a bonding manner.

Preferably, a depth of the first depth-controlled groove is greater than or equal to a thickness of the upper magnetic cover, and a depth of the second depth-controlled groove is greater than or equal to a thickness of the lower magnetic cover.

Preferably, the metal frame is a multi-layer thick copper plate, and the multi-layer thick copper plate is formed by laminating through a printed circuit board process.

Preferably, the step 2 further comprises: the first bonding layer and the second bonding layer are further arranged around the winding insulating layer; and the high-temperature resistant thin films are respectively arranged on a top surface and a bottom surface of the winding horizontal portion.

Preferably, the routing to precise depth from a top surface and a bottom surface of the second blank respectively to form a first depth-controlled groove and a second depth-controlled groove specifically comprises: making a cut at the junction of the bonding layer and the high-temperature resistant thin film, and forming a closed cutter path along the junction; and removing part of the core plate and the high-temperature resistant thin film.

Preferably, the step 2 is replaced with the following steps: plastic packaging is performed on the top surface and the bottom surface of the metal frame to form a first blank.

Preferably, the step 2 is replaced with the following steps: the metal frame is respectively laminated from the top surface and the bottom surface of the metal frame by means of a printed circuit board process to form a first blank; a top surface and a bottom surface of the first blank are both PP layers, the PP layers cover the end surface of the perpendicular portion of the winding, and the end surface of the perpendicular portion is exposed by grinding in the subsequent process.

Preferably, the step 3 is replaced with the following steps: in the first blank, corresponding positions of two adjacent ends of the metal frame are routed to form a common sidewall groove, and a protruding portion is provided in the middle of two adjacent ends; and then electroplating is performed by means of a metallization process.

Preferably, after electroplating, the electroplated layer is mechanically cut off.

Preferably, the electroplating comprises first depositing copper, and then removing copper from a top end of the protruding portion by mechanical means, and then performing electroplating.

A manufacturing process of the magnetic assembly, comprising the following steps.

Step 1: By assembling the boss on the bottom plate and the limiting hole of a corresponding winding, the winding and the bottom plate are assembled together

Step 2: The bottom plate comprises a connection rib, and the connection rib of the assembled body formed in step 1 is removed through a drilling process.

Preferably, a fitting manner between the limiting hole and the boss is an interference fit; and the bottom plate and the winding are processed in a stamping manner.

Compared with the prior art, the application has the following beneficial effects:

The present application discloses a magnetic assembly and a manufacturing process. The magnetic assembly comprises a winding assembly and a magnetic core, and the winding assembly comprises a horizontal portion and a vertical portion; by means of different manufacturing processes, on the one hand, increasing the thickness of the winding and reducing the current transmission impedance; on the other hand, the width of the winding gap is reduced, and the better performance of the multi-phase reverse coupling inductor is obtained; and the problem of the flatness of a multi-phase winding is solved.

### BRIEF DESCRIPTION OF THE DRAWINGS

FIG. 1A to FIG. 1C are schematic structural diagrams of a magnetic assembly;

FIG. 2A to FIG. 2I are a manufacturing process 1 of a magnetic assembly;

FIG. 3A to FIG. 3F are another routing process;

FIG. 4A to FIG. 4E are a manufacturing process 2 of the magnetic assembly;

FIG. 5 is a structure of a metal frame;

FIG. 6A to FIG. 6B are another metal frame structure and a manufacturing process 3;

FIG. 7 is a magnetic assembly including a signal connector.

### DETAILED DESCRIPTION OF THE EMBODIMENTS

One of the cores of the present application is to provide a magnetic assembly and a manufacturing process.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

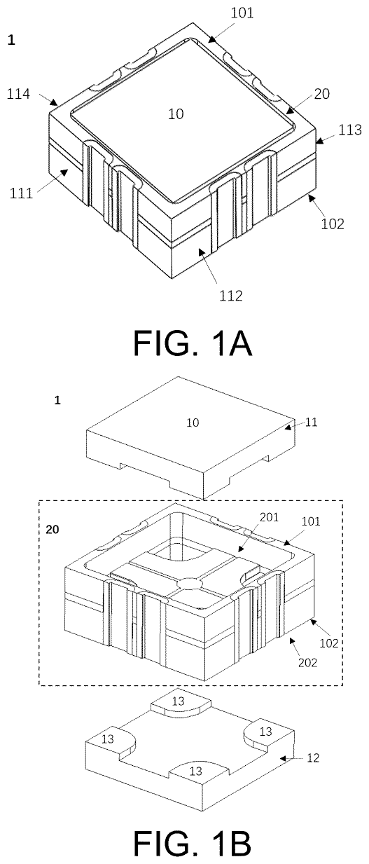

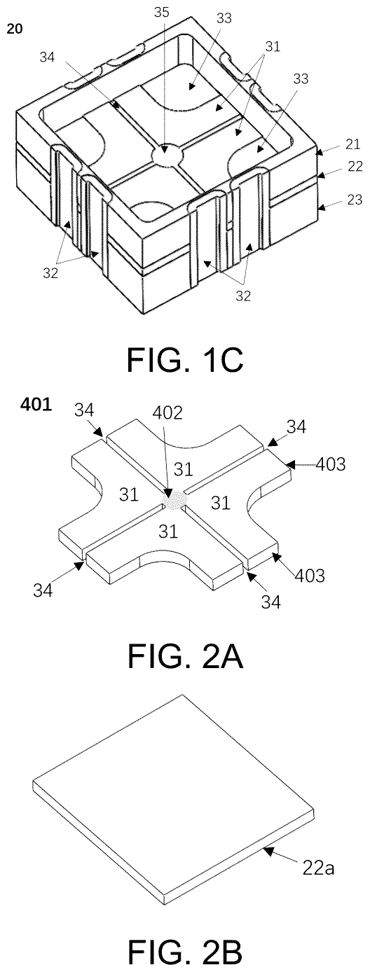

The structure of the magnetic assembly disclosed in the present application is shown in FIG. 1A to FIG. 1C. FIG. 1A is a three-dimensional structural diagram of the magnetic assembly 1, FIG. 1B is an exploded schematic diagram of FIG. 1A, and FIG. 1C is a schematic structural diagram of a winding assembly 20 of FIG. 1B. Referring to FIG. 1A to FIG. 1C, the magnetic assembly 1 is a four-phase reverse coupling integrated inductor, and comprises a magnetic core 10 and the winding assembly 20; and further comprises a top surface 101 and a bottom surface 102 opposite to each other, a first side surface 111 and a third side surface 113 opposite to each other, and a second side surface 112 and a fourth side surface 114 opposite to each other. The magnetic core 10 comprises an upper magnetic cover 11, a lower magnetic cover 12 and a magnetic column 13.

The magnetic column 13 is arranged between the upper magnetic cover 11 and the lower magnetic cover 12. The magnetic column 13 can be fixed to the upper magnetic cover and/or the lower magnetic cover together, or can be independent. The winding assembly 20 comprises a winding, an upper portion 21, an insulating layer 22, a lower portion 23, a first depth-controlled groove 201, and a second depth-controlled groove 202. The insulating layer 22 is disposed between the upper adapter portion 21 and the lower adapter portion 23. The first depth-controlled groove 201 is recessed from a top surface 101 to the winding, and the second depth-controlled groove 202 is recessed from a bottom surface 102 to the winding. A bottom of the first depth-controlled groove 201 and a bottom of the second depth-controlled groove 202 may be a surface of the winding, or may be a surface of the insulating layer. The winding assembly 20 further comprises a through hole 33, the through hole 33 is connected to the first depth-controlled groove 201 and the second depth-controlled groove 202; the through hole 33 is used for the magnetic column to pass through, the first depth-controlled groove 201 and the second depth-controlled groove 202 are respectively used for accommodating the upper magnetic cover 11 and the lower magnetic cover 12. The depth of the first depth-controlled groove is greater than or equal to the thickness of the upper magnetic cover, and the depth of the second depth-controlled groove is greater than or equal to the thickness of the lower magnetic cover.

In the present embodiment, the winding assembly 20 comprises four windings, each winding comprises a horizontal portion 31 and two vertical portions 32, the two vertical portions 32 are respectively connected to two ends of the horizontal portion 31, the two vertical portions 32 are respectively provided on two adjacent side surfaces of the magnetic assembly, and the two vertical portions 32 are penetrated through the top surface 101 and the bottom surface 102 of the magnetic assembly; the two vertical portions 32 are a first end and a second end of the same winding. The horizontal portions of the four windings are arranged on the insulating layer 22, and the horizontal portion 31 of each winding is arranged around one through hole 33; the thickness of each winding is not limited, and the width of a winding gap 34 between two adjacent windings is greater than or equal to 0.2 mm, and can even be greater than or equal to 0.1 mm; an insulating medium is provided in the winding gap 34, and the insulating medium and the medium of the insulating layer 22 are the same material; a winding slot 35 is provided between the four horizontal portions 31, and the winding groove 35 can be connected to the first depth-controlled groove 201 and second depth-controlled groove 202, and the insulating medium can also be provided in the winding groove 35.

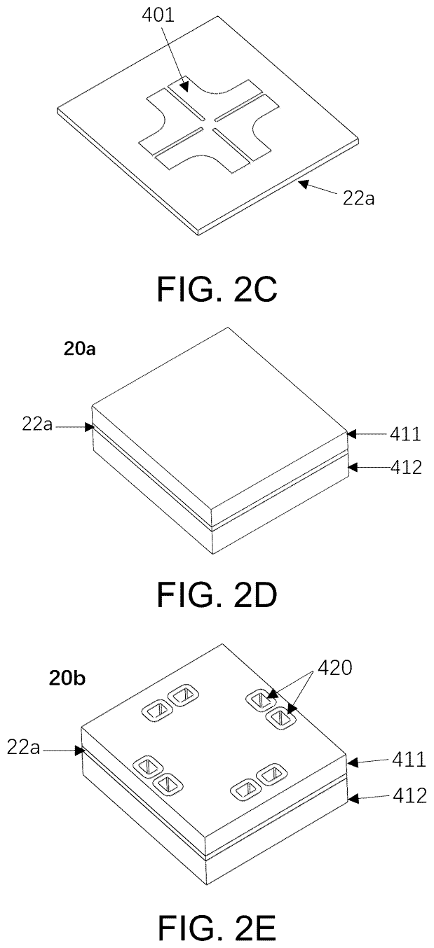

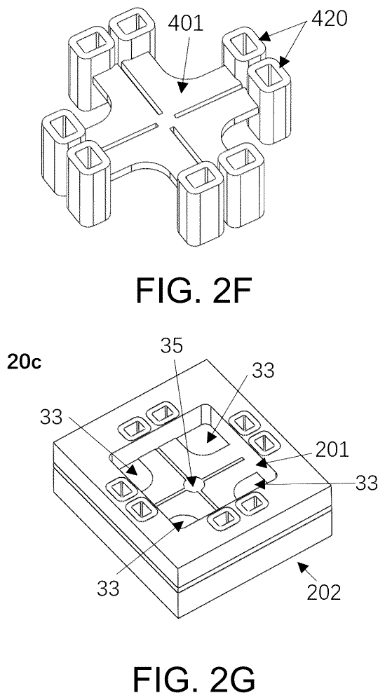

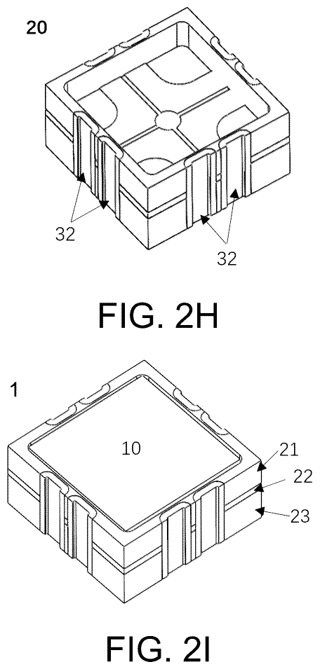

In order to achieve the flatness of a multi-phase winding, the thickness of the winding horizontal portion is increased, and the width of the winding gap 34 is reduced. A manufacturing process 1 of the winding assembly is disclosed, as shown in FIG. 2A-2I in detail.

In step 1, preparing a metal frame 401, as shown in FIG. 2A, the metal frame 401 comprises four winding horizontal portions 31 and connection rib 402, the connection rib 402 are connected to the four winding horizontal portions 31, so that the four winding horizontal portions are disposed in the same metal frame. Each winding comprises two ends 403; in production, it is also possible to adopt an integrated panel structure of multiple metal frames 401, the integrated panel structures are interconnected by winding ends of adjacent metal frames.

Step 2, pressing an insulating medium onto the metal frame 401, so that the insulating medium is fully filled the gap between the metal frames to form a winding insulating layer 22a, as shown in FIG. 2B; and optionally, removing excess insulating medium by means of a grinding plate and other processes, so that a top surface and a bottom surface of the metal frame are exposed, as shown in FIG. 2C.

Step 3, providing a first bonding layer and a top core plate 411 on a top surface of the winding insulating layer 22a, and providing a second bonding layer and a bottom core plate 412 on a bottom surface of the winding insulating layer 22a; and the first bonding layer is provided between the top core plate 411 and the winding insulating layer 22a, and the second bonding layer is provided between the bottom core plate 412 and the winding insulating layer 22a. After lamination processing, the first blank 20a is formed by high-temperature curing, the first bonding layer is a whole layer and a semi-cured sheet with fluidity is used.

Step 4, in the first blank 20 a, performing routing to form a sidewall groove at a corresponding position of each end portion of the winding, so that each end portion is exposed to an inner wall of the sidewall groove; performing a metallization process and electroplating, so that a electroplated layer 420 is connected to the end portion 403 of the metal frame 401 to form a second blank 20b, as shown in FIG. 2E; if all of the medium is removed, only the electroplated layer 420 and the metal frame 401 are retained, an internal structure of which is shown in FIG. 2F.

Step 5, routing to precise depth from a top surface and a bottom surface of the second blank 20b respectively to form a first depth-controlled groove 201 and a second depth-controlled groove 202; performing a drilling process in the middle of the bottom of the depth-controlled groove to remove the connection rib 402 to form a winding groove 35, so that the metal frame becomes four independent winding horizontal portions 31. Performing a drilling process at four corners of the depth-controlled groove to form four through holes 33 for the magnetic column to pass through.

Step 6, a third blank 20c generated in step 5 is divided along the sidewall groove to form the winding assembly 20, and the partially electroplated layer 420 is exposed to the winding assembly 20 to form the vertical portion 32 of the winding; the two vertical portions 32 provided on the same side of the winding assembly 20 are respectively a first end of one winding and a second end of the other winding, and the two vertical portions are opposite-polarity electrodes.

Further, the magnetic column 13 is passed through the through hole 33, and the upper magnetic cover 11 and the lower magnetic cover 12 are respectively assembled from the first depth-controlled groove 201 and the second control depth groove 202 to fix the magnetic core 10 and the winding assembly 20 to form a magnetic assembly 1. The bonding fixing manner is used, and the bonding material is preferably made of organic silica gel; however, the fixing manner and the bonding material are not limited thereto.

Preferably, the depth of the first depth-controlled groove 201 in step 5 is greater than the thickness of the upper magnetic cover 11, and the depth of the second depth-controlled groove 202 is greater than the thickness of the lower magnetic cover 12.

Furthermore, the plurality of winding assemblies 20 or the magnetic assembly 1 may be placed in a fixed-height mold, and an upper surface of the upper portion 21 and/or an bottom surface of the lower portion 23 are mechanically ground, so that the top surface of the upper portion 21 and/or the bottom surface of the lower adapter 23 are flush with a surface of the vehicle, thereby achieving the consistency of the heights of the plurality of magnetic assemblies.

By means of the manufacturing process 1, on the one hand, the direct current impedance o the horizontal portion and the vertical portion of the winding can be reduced, thereby reducing the loss of the magnetic assembly; on the other hand, the consistency of the heights of the magnetic assemblies is realized, thereby meeting the flatness requirement of the multi-phase winding.

In addition, as an alternative, the metal frame in step 1 can be a multi-layer thick copper plate, and the multi-layer thick copper plate is formed by laminating through a printed circuit board process. Optionally, step 2 may be skipped and proceed directly to step 3; or after skipping step 2, replace it with a modified step 3 as follows: plastic packaging is performed on the top surface and the bottom surface of the metal frame to form the first blank 20a.

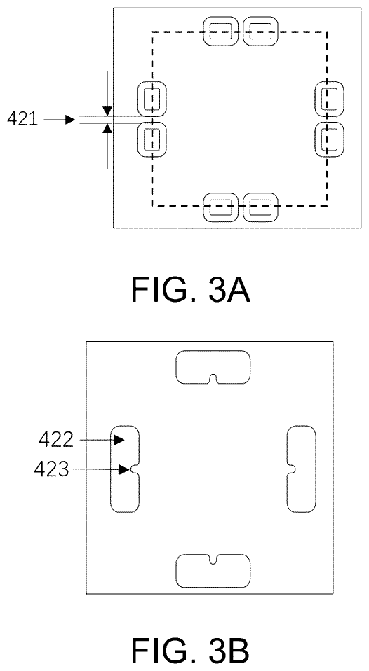

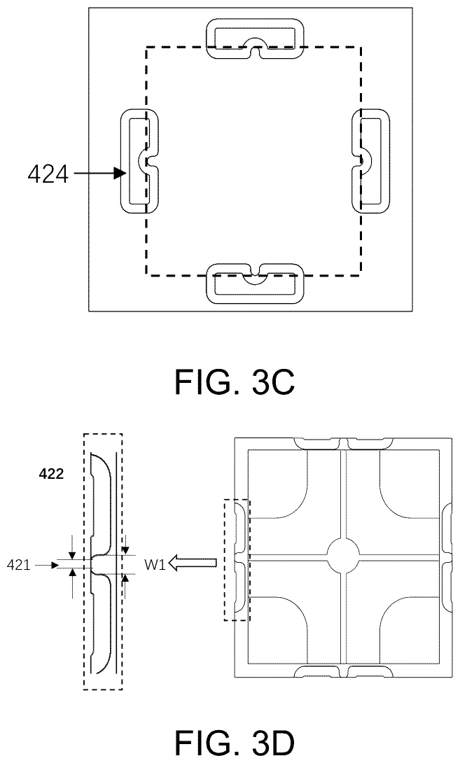

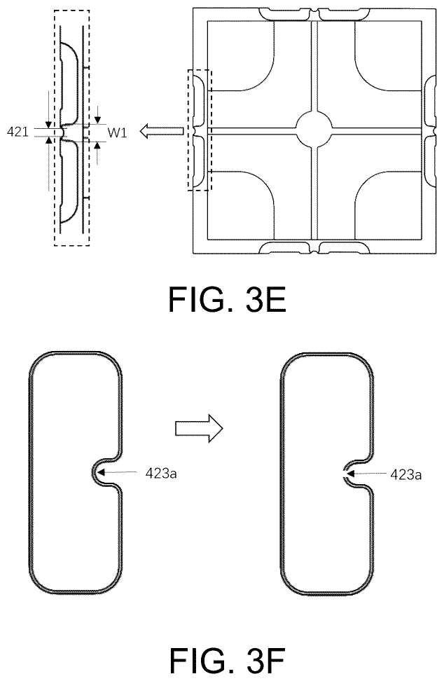

Further, in step 4, the gap between the two sidewall grooves on the same side of the winding assembly is a side groove gap 421, as shown in FIG. 3A; and according to the printed circuit board process, the minimum gap between the two sidewall grooves is 0.6 mm, so that the side groove gap 421 does not satisfy the spacing requirement between the multi-phase windings. Therefore, another routing process is disclosed. Two adjacent vertical portions in the manufacturing process 1 are shared one sidewall groove, and after electroplating, the electroplated layer is mechanically cut off, so as to reduce the distance between adjacent electrodes, as shown in FIG. 3B to FIG. 3D. Therefore, step 4 in the manufacturing process 1 may be replaced with:
Step 4: In the first blank 20a, corresponding positions of two adjacent ends of the metal frame are subjected to rout to form the common sidewall groove 422. As shown in FIG. 3B, the common sidewall groove 422 is a special-shaped groove, that is, a protruding portion 423 is arranged in the middle of two adjacent ends. Because a continuous routing is used during the machining process, a width W1 of the protruding portion can be made small, such as 0.4 mm. Then forming an electroplated coating by a the metallization process (i.e. copper deposition and re-electroplating), as shown in FIG. 3C; and then dividing the plate along a dashed line (in FIG. 3C) to form the winding assembly 20 as shown in FIG. 3D; and the side groove gap 421 of the winding assembly may be greater than or equal to 0.3 mm. Therefore, the requirement of small gaps between the multi-phase windings can be achieved by means of the routing process, and the requirements for insulation are met; in addition, the distance between the vertical portions of the windings is optimized, and the size of the magnetic assembly is ensured to be the same as the size of the magnetic assembly of one manufacturing process.

In addition, in the aforementioned routing process, the problem of a burr may be generated. Therefore, during a cutting process, the position of the protruding portion may be concave, and a tool path is increased. In this way, the problem of a burr can be effectively avoided; the requirement of small gaps between the multi-phase windings is realized, and the reliability of the power conversion device is ensured.

Further, in the aforementioned routing process, after the copper is deposited, the copper deposited on a top end 423a of the protruding portion can be removed by mechanical means, as shown in FIG. 3F; and when electroplating is performed, because the top end 423a of the protruding portion is free of copper, the top end cannot be electroplated. In the present embodiment, the copper deposited has a thickness of several micrometers, and the copper deposited is mechanically removed, so that the formed burr is reduced, so that the requirements of small gaps between the multi-phase windings and the reliability of the power conversion device are better achieved.

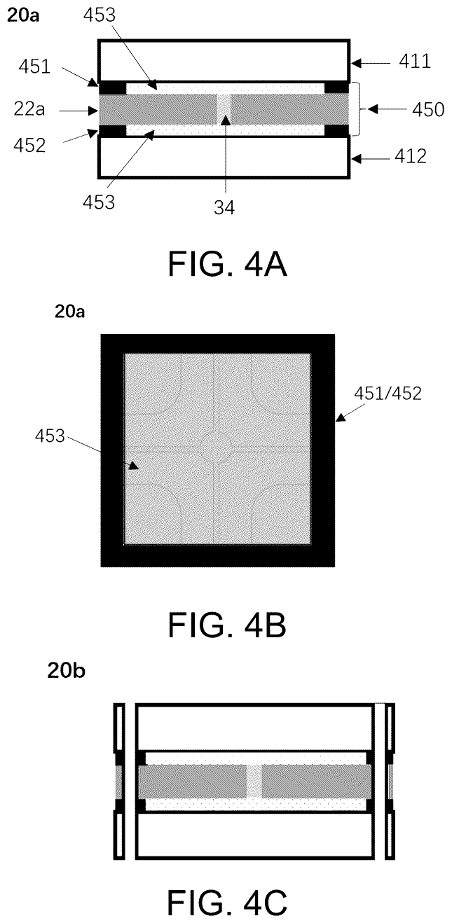

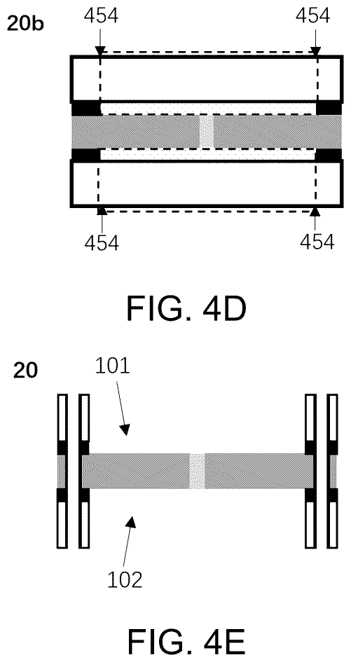

Optionally, the present application further provides a manufacturing process 2, wherein the steps 1 and 2 are the same as those in step 1 and step 2 in the manufacturing process 1, and the step 3 and subsequent steps can adopt the following structures and processes, as shown in FIG. 4A to FIG. 4D.

Step 3, Referring to FIG. 4A and FIG. 4B, the first bonding layer 451 and the second bonding layer 452 are respectively provided on the top surface and the bottom surface of the winding insulating layer 22a formed in step 2, and are arranged around the winding insulating layer 22a; the first bonding layer and the second bonding layer use semi-cured sheets having poor fluidity; and an intermediate region 453 (i.e. the top surface and the bottom surface of the winding horizontal portion) are respectively provided with high-temperature resistant thin films. As shown in FIG. 4A, a first combination 450 comprises the winding insulating layer 22a, the first bonding layer 451, the second bonding layer 452, and the high-temperature resistant thin film. The top core plate 411 and the bottom core plate 412 are respectively provided on the top surface and the bottom surface of the first assembly 450, and there is no bonding between the high-temperature resistant thin film and the top core plate 411/the bottom core plate 412; the top core plate 411 is fixed by means of the first bonding layer 451 and the winding insulating layer 22a; the bottom core plate 412 is fixed by means of the second bonding layer 452 and the winding insulating layer 22a to form a first blank 20a; as shown in FIGS. 4A and 4B, FIG. 4A is a side cross-sectional view of the first blank 20a, and FIG. 4B is a perspective view of the top surface of the first blank 20a.

Step 4: forming the sidewall groove by using step 4 in the manufacturing process 1 to perform metallization process electroplating to form the second blank 20b, as shown in FIG. 4C.

Step 5, as shown in FIG. 4D, the positions of beginning cutting is respectively formed from a position 454 (i.e. a junction between the bonding layer and the high-temperature-resistant thin film) of the top surface and the bottom surface of the second blank 20b, and a closed cutter path is formed at the junction; a part of the core plate and the high-temperature resistant thin film can be removed, a first depth-controlled groove 101 is formed on the top surface, and a second depth-controlled groove 102 is formed on the bottom surface as shown in FIG. 4D and FIG. 4E.

Then, the step 6 in the manufacturing process 1 is used to divide the plate.

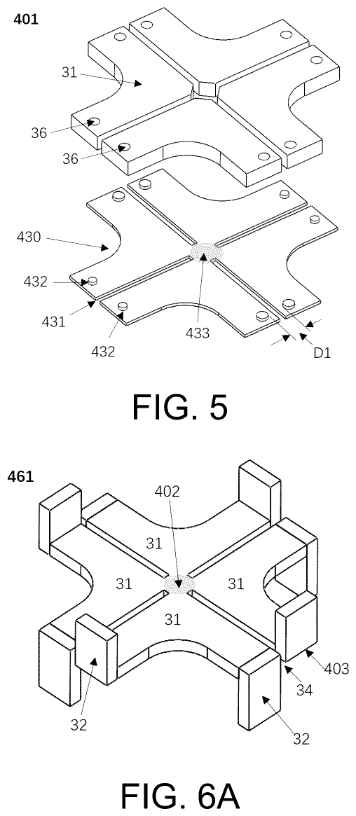

On the other hand, because the loss of the winding in the magnetic assembly is relatively high, increasing the thickness of the winding is a conventional choice under the condition that the cross-sectional size of the magnetic component is limited; however, when the metal frame is formed by using a stamping process, the spacing between adjacent windings is required to be at least 1-1.5 times the thickness of a metal plate, so that the thickness of the winding is increased, and the gap between adjacent windings is reduced, which is an urgent problem to be solved. The present application provides a metal frame structure and a manufacturing process. As shown in FIG. 5, the metal frame 401 comprises a winding horizontal portion 31 and a bottom plate 430; each winding horizontal portion 31 comprises two limiting holes 36, and each limiting hole 36 is provided adjacent to the end portion of the winding horizontal portion 31. In the present embodiment, four winding horizontal portions 31 are comprised, and each winding horizontal portion is independent and has no connection rib. The bottom plate 430 may be independent or may be an integrated panel structure. the structure of the bottom plate 430 is similar to the metal frame structure shown in FIG. 2A, and comprises a bottom plate gap 431 and the connection rib 433, and the difference lies in further comprising a plurality of bosses 432, each boss 432 being arranged adjacent to an end portion of the bottom plate; The spacing between two adjacent bosses is D1; the assembly of the winding and the bottom plate is completed by assembling the boss 432 and the limiting hole 36 of the corresponding winding; the preferred fitting manner between the limiting hole and the boss is an interference fit. In the present embodiment, the bottom plate 430 serves as a carrier, and the thickness of the bottom plate can be made very thin, such as 0.1 mm. Therefore, when the bottom plate is processed, a minimum width of the bottom plate gap 431 can be 0.1 mm, and the typical value is about 0.15 mm. After the bottom plate 430 and the winding horizontal portion 31 are assembled, the width of the spacing between the winding horizontal portions is determined by the size of the bosses and the accuracy of the spacing D1 between adjacent bosses; the boss 432 is processed by means of die stamping, and the tolerance of the boss and the spacing between adjacent bosses can all be made high, for example, the tolerance is 0.05 mm; the winding horizontal portion 31 is also processed by means of die stamping, so that a position tolerance of the limiting hole 36 can also be made high; after the winding horizontal portion and the bottom plate are assembled, taking into account tolerance accumulation, the minimum width of the winding gap between adjacent winding horizontal portions can be 0.2 mm, and the typical value is about 0.3 mm. Thus, the thickness of the winding horizontal portion and the winding gap can be decoupled, so that the thickness of the winding horizontal portion can be increased, and the winding gap can be reduced. The metal frame after assembling may use the steps of manufacturing process 1. In the present embodiment, the bottom plate 430 may be made of a metal material or a non-metal material; if the bottom plate 430 is made of the metal material, the bottom plate gap 431 must be retained, in a subsequent step, connection rib 433 is removed by means of a drilling process. If the bottom plate is made of the non-metal material, the bottom plate 430 may not be provided with the bottom plate gap 431, and connection rib 433 may not be removed in the subsequent process.

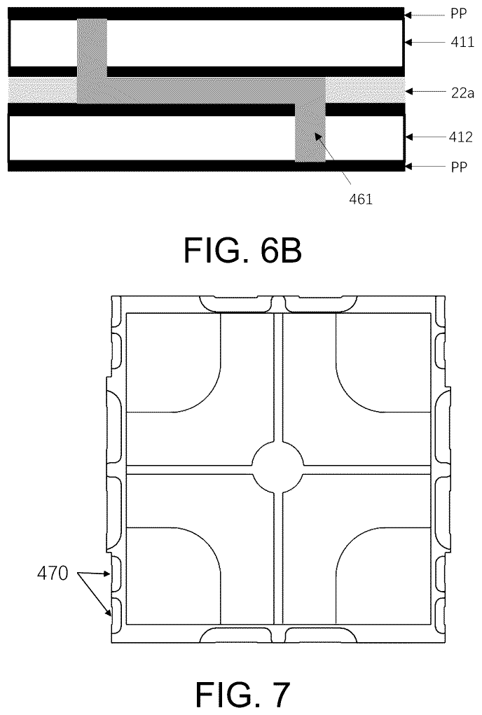

The present application further provides another metal frame structure and a manufacturing process 3, as shown in FIG. 6A and FIG. 6B. FIG. 6A is a schematic structural diagram of a metal frame 461. The metal frame 461 comprises four phase windings. Each winding comprises the horizontal portion 31 and two vertical portions 32. The horizontal portion and the vertical portion of the metal frame can be integrally and formed to a unit, or can be bent to form the vertical portion after being integrally and formed to a unit. Therefore, the horizontal portion and the vertical portion have the same thickness. There is the winding gap 34 between adjacent windings; the metal frame 461 further comprises a connection rib 402, and the connection rib 402 is connected to each winding. The metal frame is respectively pressed from the top surface and the bottom surface of the metal frame by means of the printed circuit board process to form the first blank 20a, as shown in FIG. 6B, the top surface and the bottom surface of the first blank 20a are both PP layers, the PP layer covers the end surface of the vertical portion of the winding, and in the subsequent process, the end surface of the vertical portion is exposed by grinding; in other embodiments, the first blank 20a may also be formed by a plastic packaging process, and then the winding assembly 20 is formed by subsequent steps in the foregoing manufacturing process.

Optionally, in the foregoing embodiment, a signal connector 470 may be disposed on a side surface of the magnetic assembly, as shown in FIG. 7. The signal connector 470 can adopt the same process as the vertical portion of the winding, and can also realize the signal connector in the step of the vertical portion. In addition, the signal connector needs to be ground together with the copper winding vertical portion.

The power supply module device according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120] ; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A magnetic assembly, comprising a top surface and a bottom surface opposite to each other, a first side surface and a third side surface opposite to each other, a second side surface and a fourth side surface opposite to each other, a winding assembly and a magnetic core, wherein the magnetic core comprises an upper magnetic cover, a lower magnetic cover and a magnetic column, and the magnetic column is disposed between the upper magnetic cover and the lower magnetic cover;
the winding assembly comprises a plurality of windings, an upper portion, an insulating layer, a lower portion, a first depth-controlled groove, a second depth-controlled groove, and a through hole, and the upper portion and the lower portion are respectively disposed on a top surface of the insulating layer and a bottom surface of the insulating layer; each of the plurality of windings comprises a horizontal portion and a vertical portion, the horizontal portion is disposed in the insulating layer, the vertical portion is disposed at two ends of the horizontal portion, and the vertical portion is penetrated the top surface of the magnetic assembly and the bottom surface of the magnetic assembly; two vertical portions in one of the plurality of windings are respectively arranged on two adjacent side surfaces, and two vertical portions arranged on the same side surface are opposite-polarity electrodes; the first depth-controlled groove is recessed from a top surface of the winding assembly, and the first depth-controlled groove is used for accommodating the upper magnetic cover; the second depth-controlled groove is recessed from a bottom surface of the winding assembly, and the second depth-controlled groove is used for accommodating the lower magnetic cover; the through hole is connected to the first depth-controlled groove and the second depth-controlled groove, and the through hole is used for the magnetic column to pass through;
there is a winding gap between two adjacent horizontal portions, and a thickness of the vertical portion is equal to a thickness of the horizontal portion.

2. The magnetic assembly of claim 1, wherein a depth of the first depth-controlled groove is greater than or equal to a thickness of the upper magnetic cover, and a depth of the second depth-controlled groove is greater than or equal to a thickness of the lower magnetic cover.

3. The magnetic assembly of claim 1, wherein a distance between two vertical portions of the same side surface is less than or equal to the thickness of the vertical portion of the each of the plurality of windings.

4. The magnetic assembly of claim 1, wherein a protruding portion is disposed between two vertical portions of the same side surface, and the protruding portion maintains electrical insulation between the two vertical portions.

5. The magnetic assembly of claim 1, wherein the magnetic assembly further comprises a signal electrical connector disposed on the side surface of the magnetic assembly and penetrating through the top surface of the magnetic assembly and the bottom surface of the magnetic assembly.

6. The magnetic assembly of claim 1, wherein the number of the plurality of windings is four, and the each of the plurality of windings comprises the horizontal portion and the two vertical portions; the winding assembly further comprises a winding groove; the winding groove is disposed between four horizontal portions, and the winding groove connected to the first depth-controlled groove and the second depth-controlled groove.

7. The magnetic assembly of claim 1, wherein the through hole is disposed at four corners of at least one depth-controlled groove, and the through hole is surrounded by the horizontal portion of the each of the plurality of windings.

8. The magnetic assembly of claim 6, wherein an insulating medium is disposed in the winding gap and the winding groove.

9. The magnetic assembly of claim 1, wherein the number of the plurality of windings is four, the each of the plurality of windings comprises the horizontal portion and the two vertical portions, and each horizontal portion is independently arranged; the winding assembly further comprises a bottom plate; the bottom plate comprises a plurality of bosses; the each of the plurality of bosses is arranged adjacent to an end portion of the bottom plate, and there is a boss gap between adjacent two of the plurality of bosses; each horizontal portion of the each of the plurality of windings comprises two limiting holes, and the two limiting holes are respectively arranged adjacent to two ends of the horizontal portion; positions of the plurality of bosses and the limiting holes are in one-to-one correspondence.

10. The magnetic assembly of claim 9, wherein the bottom plate is made of a metal material, and the bottom plate further comprises a bottom plate gap; and a width of the bottom plate gap is less than the thickness of the horizontal portion.

11. The magnetic assembly of claim 1, wherein the horizontal portion and the vertical portion are integrally and formed to a unit, or the horizontal portion and the vertical portion are integrally and formed to a unit and bent to form the vertical portion.

12. A manufacturing process of the magnetic assembly of claim 1, comprising the following steps:
Step 1: preparing a metal frame, wherein the metal frame comprises four horizontal portions and a connection rib; the connection rib is connected to four horizontal portions;
Step 2: arranging a first bonding layer and a top core plate on a top surface of the metal frame, providing a second bonding layer and a bottom core plate on a bottom surface of the metal frame, and performing high-temperature curing after lamination to form a first blank;
Step 3: in the first blank, performing routing to form a sidewall groove at a corresponding position of each end portion of the each of the plurality of windings, so that the each end portion is exposed to an inner wall of the sidewall groove; performing a metallization process on the sidewall groove and electroplating, so that an electroplated layer is connected to the corresponding end portion to form a second blank;
Step 4: routing to a precise depth from a top surface of the second blank and a bottom surface of the second blank respectively to form the first depth-controlled groove and the second depth-controlled groove, and then drilling away the connection rib at a bottom of at least one depth-controlled groove, or drilling to form the through hole.

13. The manufacturing process of claim 12, wherein the metal frame is an integrated panel structure;
the manufacturing process further includes step 5: dividing a plate along the sidewall groove to form the winding assembly; and exposing a part of the electroplated layer to the winding assembly to form the vertical portion of the winding.

14. The manufacturing process of claim 13, wherein the winding assembly is placed in a fixed-height mold, and a top surface of the upper portion and/or a bottom surface of the lower portion are mechanically ground.

15. The manufacturing process of claim 12, further comprising the following steps before step 2: pressing an insulating medium on the metal frame, so that the insulating medium is fully filled the winding gap between metal frames to form a winding insulating layer; and removing the excess insulating medium, so that the top surface of the metal frame and the bottom surface of the metal frame are exposed.

16. The manufacturing process of claim 13, further passing the magnetic column through the through hole, and assembling the upper magnetic cover and the lower magnetic cover respectively from the first depth-controlled groove and the second depth-controlled groove to fix the magnetic core and the winding assembly to form the magnetic assembly.

17. The manufacturing process of claim 16, wherein the magnetic core and the winding assembly are fixed in a bonding manner.

18. The manufacturing process of claim 12, wherein a depth of the first depth-controlled groove is greater than or equal to a thickness of the upper magnetic cover, and a depth of the second depth-controlled groove is greater than or equal to a thickness of the lower magnetic cover.

19. The manufacturing process of claim 12, wherein the metal frame is a multi-layer thick copper plate, and the multi-layer thick copper plate is formed by laminating through a printed circuit board process.

20. The manufacturing process of claim 12, wherein the step 2 further comprises: the first bonding layer and the second bonding layer are further arranged around the a winding insulating layer; and high-temperature resistant thin films are respectively arranged on a top surface of the horizontal portion and a bottom surface of the horizontal portion.

21. The manufacturing process of claim 20, wherein the routing to a precise depth from a top surface of the second blank and a bottom surface of the second blank respectively to form the first depth-controlled groove and the second depth-controlled groove specifically comprises: making a cut at a junction of the bonding layers and one of the high-temperature resistant thin films, and forming a closed cutter path along the junction; and removing part of the core plate and one of the high-temperature resistant thin films.

22. The manufacturing process of claim 12, wherein the step 2 is replaced with the following steps: plastic packaging is performed on a top surface of the metal frame and a bottom surface of the metal frame to form a first blank.

23. The manufacturing process of claim 12, wherein the step 2 is replaced with the following steps: the metal frame is respectively laminated from a top surface of the metal frame and a bottom surface of the metal frame by means of a printed circuit board process to form a first blank; a top surface of the first blank and a bottom surface of the first blank are both PP layers, the PP layers cover end surface of the vertical portion of the winding, and the end surface of the vertical portion is exposed by grinding in a subsequent process.

24. The manufacturing process of claim 12, wherein the step 3 is replaced with the following steps: in the first blank, corresponding positions of two adjacent ends of the metal frame are subjected to rout to form a common sidewall groove, and a protruding portion is provided in a middle of the two adjacent ends; and then electroplating is performed by means of a metallization process.

25. The manufacturing process of claim 24, wherein after electroplating, the electroplated layer is mechanically cut off.

26. The manufacturing process of claim 24, wherein the electroplating comprises: depositing copper first, and then removing copper from a top end of the protruding portion by mechanical means, and then performing electroplating.

27. A manufacturing process of the magnetic assembly of claim 10, comprising the following steps:
Step 1: by assembling the each of the plurality of bosses on the bottom plate and each of the limiting holes of a corresponding winding, the corresponding winding and the bottom plate are assembled together;
Step 2: the bottom plate comprises a connection rib, and the connection rib of an assembled body formed in step 1 is removed through a drilling process.

28. The manufacturing process of the magnetic assembly of claim 27, wherein a fitting manner between the each of the limiting holes and the each of the plurality of bosses is an interference fit; and the bottom plate and the corresponding winding are processed in a stamping manner.
